(19) United States
(12) Patent Application Publication
(10) Pub. No.: US 2026/0268691 A1
(43) Pub. Date: Sep. 10, 2026

(54) SEQUENCE-BASED SYSTEMS AND METHODS FOR DECODING COMPLEX SIGNBOARDS

(71) Applicant: QUALCOMM Incorporated, San Diego, CA (US)

(72) Inventors: Karl Olof Erik Wernholt, Linköping (SE); Carl Per Gunnar Ekman, Linköping (SE); Patrick Hiemsch, Linköping (SE); Akshay Gurudath, Linköping (SE); Shirdi Manjunath Adigarla, Norrköping (SE); Fredrik Mjoerning, Linköping (SE)

(21) Appl. No.: 19/072,548

(22) Filed: Mar. 6, 2025

(51) Int. Cl. G06V 20/58; G06V 10/764; G06V 10/77; G06V 30/19

(52) U.S. Cl. CPC G06V 20/582; G06V 10/764; G06V 10/7715; G06V 30/19173

(57) ABSTRACT

This disclosure provides systems, methods, and devices for vehicle driving assistance systems that support image processing. In a first aspect, a method of image processing includes receiving an image frame representing a scene and extracting a first image patch of the image frame. The first image patch includes a first plurality of pixels representing a signboard including information in the scene. The operations further include determining, based on the first image patch, each symbol of a plurality of symbols included in the information and an order in which the plurality of symbols are arranged on the signboard. Other aspects and features are also claimed and described.

### TECHNICAL FIELD

Aspects of the present disclosure relate generally to driver-operated or driver-assisted vehicles, and more particularly, to methods and systems suitable for supplying driving assistance or for autonomous driving.

### INTRODUCTION

Vehicles take many shapes and sizes, are propelled by a variety of propulsion techniques, and carry cargo including humans, animals, or objects. These machines have enabled the movement of cargo across long distances, movement of cargo at high speed, and movement of cargo that is larger than could be moved by human exertion. Vehicles originally were driven by humans to control speed and direction of the cargo to arrive at a destination. Human operation of vehicles has led to many unfortunate incidents resulting from the collision of vehicle with vehicle, vehicle with object, vehicle with human, or vehicle with animal. As research into vehicle automation has progressed, a variety of driving assistance systems have been produced and introduced. These include navigation directions by GPS, adaptive cruise control, lane change assistance, collision avoidance systems, night vision, parking assistance, and blind spot detection. Various driving, or movement, assistance systems have also been produced in machine automation generally, such as in robotics.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Human operators of vehicles can be distracted, which is one factor in many vehicle crashes. Driver distractions can include changing the radio, observing an event outside the vehicle, and using an electronic device, etc. Sometimes circumstances create situations that even attentive drivers are unable to identify in time to prevent vehicular collisions. Aspects of this disclosure, provide improved systems for assisting drivers in vehicles with enhanced situational awareness when driving on a road. Aspects of this disclosure also provide improved systems for assisting users of non-vehicle systems such as robotics.

Example embodiments may improve autonomous driving systems through improved object detection, although aspects of the object detection processing described herein may also be applied to other applications, such as object detection on camera systems, including camera systems on mobile phones, or such as other machine control-assistance systems or automation systems generally. Object detection techniques may be used to detect one or more objects in a scene. For example, object detection can be used to detect or identify one or more positions and/or locations of markings in an environment. Examples of fields where a device may determine the position and/or location of markings include autonomous driving by autonomous driving systems (e.g., of autonomous vehicles), autonomous navigation by a robotic system (e.g., an automated vacuum cleaner, an automated surgical device, etc.), among others. For instance, a three-dimensional (3D) environment may include markings to facilitate navigation through the environment, such as signboards (e.g., traffic signs). It can be important for the autonomous device to detect such markings and accurately navigate the space relative to such markings.

Example embodiments provide image processing techniques for interpreting complex signboards that convey multiple informative parts. The techniques detect a signboard in an image frame and detect each informative part on the signboard. For example, an informative part may be multiple symbols (e.g., letters) that form a word or may be multiple symbols that each convey their own information (e.g., a parking symbol and a taxi symbol). The techniques further include, for each informative part, determining each symbol that is included in the informative part and an order in which the determined symbols are arranged on the signboard. The ordered sequence of symbols may then be used for downstream tasks, such as controlling steering of a vehicle. Additional aspects of the provided techniques are detailed in the remaining description and in the figures.

In one aspect of the disclosure, an image processing method includes receiving an image frame representing a scene and extracting a first image patch of the image frame. The first image patch includes a first plurality of pixels representing a signboard including information in the scene. The operations further include determining, based on the first image patch, each symbol of a plurality of symbols included in the information and an order in which the plurality of symbols are arranged on the signboard.

In an additional aspect of the disclosure, an apparatus includes at least one processor and a memory coupled to the at least one processor. The at least one processor is configured to perform operations including receiving an image frame representing a scene and extracting a first image patch of the image frame. The first image patch includes a first plurality of pixels representing a signboard including information in the scene. The operations further include determining, based on the first image patch, each symbol of a plurality of symbols included in the information and an order in which the plurality of symbols are arranged on the signboard.

In an additional aspect of the disclosure, a non-transitory computer-readable medium stores instructions that, when executed by a processor, cause the processor to perform operations. The operations include receiving an image frame representing a scene and extracting a first image patch of the image frame. The first image patch includes a first plurality of pixels representing a signboard including information in the scene. The operations further include determining, based on the second image patch, each symbol of a plurality of symbols included in the information and an order in which the plurality of symbols are arranged on the signboard.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) ng networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). 5G networks include diverse deployments, diverse spectrum, and diverse services and devices that may be implemented using an OFDM-based unified, air interface.

The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band. 5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur.

Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a perspective view of a motor vehicle with a driving assistance system according to embodiments of this disclosure.

FIG. 2 shows a block diagram of an example image processing configuration for a vehicle according to one or more aspects of the disclosure.

FIG. 3 is a block diagram illustrating details of an example wireless communication system according to one or more aspects.

FIG. 4 is a block diagram illustrating a system for determining, using image processing techniques, an ordered sequence of symbols included on a signboard according to one or more aspects of the disclosure.

FIG. 5 is a block diagram of an example machine learning (ML) model represented by an artificial neural network (ANN) according to one or more aspects of the disclosure.

FIG. 6 is a flow diagram illustrating an example pipeline for determining, using image processing techniques, an ordered sequence of symbols included on a signboard according to one or more aspects of the disclosure.

FIG. 7 is a flow diagram illustrating an example method for determining, using a connectionist temporal classification (CTC) algorithm, the ordered sequence of symbols from an image patch according to one or more aspects of the disclosure.

FIG. 8 is a flow diagram illustrating an example method for determining, using a CTC algorithm, whether a symbol is associated with an attribute according to one or more aspects of the disclosure.

FIG. 9 is a flow diagram illustrating an example method for annotating training data and verification data according to one or more aspects of the disclosure.

FIG. 10 is a flow chart illustrating an example method for determining, using image processing techniques, an ordered sequence of symbols included on a signboard according to one or more aspects of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support determining, using image processing techniques, an ordered sequence of symbols included on a signboard (e.g., a traffic sign). The image processing techniques include using object detection to detect a signboard in an image frame. A sign image patch representing the detected signboard may be extracted from the image frame. Object detection may further be used to detect, in the sign image patch, one or more rows or columns of information conveyed by the signboard. For example, the signboard may indicate a rest stop in a first row, services offered at the rest stop in a second row, and a distance to the rest stop in a third row. An information image patch representing a row or column of information may be extracted from the sign image patch for each detected row or column.

For each information image patch, each of the symbols conveying the information may be extracted into an ordered symbol sequence. Rather than using object detection to extract an image patch including a symbol, however, the provided techniques involve at least one machine learning model trained to read the information by extracting each individual symbol and determining the order of the extracted symbols. For example, if the signboard indicates a rest stop with the words “Rest Stop,” then each individual letter of the two words is a symbol that is extracted and ordered to match the words on the signboard. In another example, if the signboard indicates the services provided at the rest stop with a gas station symbol, a dining symbol, and a restaurant symbol, then each of these three symbols is extracted and ordered. The ordered symbol sequences may thereafter be used in a downstream task, such as to control operations of an autonomous vehicle to drive to the rest stop.

Particular implementations of the subject matter described in this disclosure may be implemented to realize one or more of the following potential advantages or benefits. In some aspects, the present disclosure provides techniques for image processing that may be particularly beneficial in smart vehicle applications. For example, the proposed techniques offer a less computationally expensive approach to processing information on signboards, such as road signage. In particular, these techniques provide an efficient representation of information conveyed by complex traffic signs that is easy to annotate and directly estimate in a machine learning model. For instance, rows or columns of symbols on road signage may be more efficiently annotated by eliminating the need for each symbol to be annotated or detected with individual bounding boxes. The techniques also require less post-processing because, by eliminating the individual bounding boxes for each symbol, the output is already well-structured.

One benefit of improved efficiency in processing information on road signage is that it allows vehicle control systems to more quickly make decisions for navigating vehicles in view of changing conditions. This can be particularly useful in situations where there may be unexpected obstructions or road conditions that could pose a hazard to drivers and road signage indicates these obstructions or road conditions. Additionally, improved processing of road signage can help to improve overall safety on the roads by reducing vehicle collisions. With more efficient processing capabilities, vehicles can be made more responsive to information physically conveyed in the environment around the vehicles and can be routed according to that information more efficiently. These improvements can also extend to driver assistance systems, which can benefit from more efficient monitoring capabilities. By improving the computational efficiency of processing information conveyed by road signage, these systems can offer improved navigation and assistance to drivers when necessary, without generating unnecessary notifications or distractions.

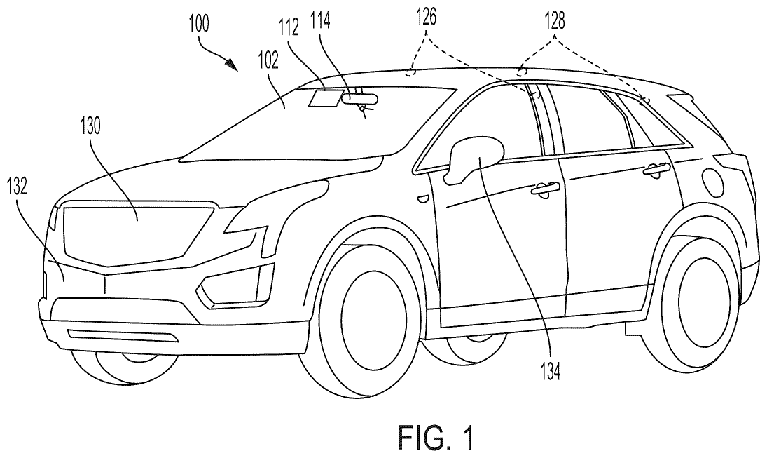

FIG. 1 is a perspective view of a motor vehicle with a driving assistance system according to embodiments of this disclosure. A vehicle 100 may include a front-facing camera 112 mounted inside the cabin looking through the windshield 102. The vehicle may also include a cabin-facing camera 114 mounted inside the cabin looking towards occupants of the vehicle 100, and in particular the driver of the vehicle 100. Although one set of mounting positions for cameras 112 and 114 are shown for vehicle 100, other mounting locations may be used for the cameras 112 and 114. For example, one or more cameras may be mounted on one of the driver or passenger B pillars 126 or one of the driver or passenger C pillars 128, such as near the top of the pillars 126 or 128. As another example, one or more cameras may be mounted at the front of vehicle 100, such as behind the radiator grill 130 or integrated with bumper 132. As a further example, one or more cameras may be mounted as part of a driver or passenger side mirror assembly 134.

The camera 112 may be oriented such that the field of view of camera 112 captures a scene in front of the vehicle 100 in the direction that the vehicle 100 is moving when in drive mode or forward direction. In some embodiments, an additional camera may be located at the rear of the vehicle 100 and oriented such that the field of view of the additional camera captures a scene behind the vehicle 100 in the direction that the vehicle 100 is moving when in reverse direction. Although embodiments of the disclosure may be described with reference to a “front-facing” camera, referring to camera 112, aspects of the disclosure may be applied similarly to a “rear-facing” camera facing in the reverse direction of the vehicle 100. Thus, the benefits obtained while the operator is driving the vehicle 100 in a forward direction may likewise be obtained while the operator is driving the vehicle 100 in a reverse direction.

Further, although embodiments of the disclosure may be described with reference a “front-facing” camera, referring to camera 112, aspects of the disclosure may be applied similarly to an input received from an array of cameras mounted around the vehicle 100 to provide a larger field of view, which may be as large as 360 degrees around parallel to the ground and/or as large as 360 degrees around a vertical direction perpendicular to the ground. For example, additional cameras may be mounted around the outside of vehicle 100, such as on or integrated in the doors, on or integrated in the wheels, on or integrated in the bumpers, on or integrated in the hood, and/or on or integrated in the roof.

The camera 114 may be oriented such that the field of view of camera 114 captures a scene in the cabin of the vehicle and includes the user operator of the vehicle, and in particular the face of the user operator of the vehicle with sufficient detail to discern a gaze direction of the user operator.

Each of the cameras 112 and 114 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

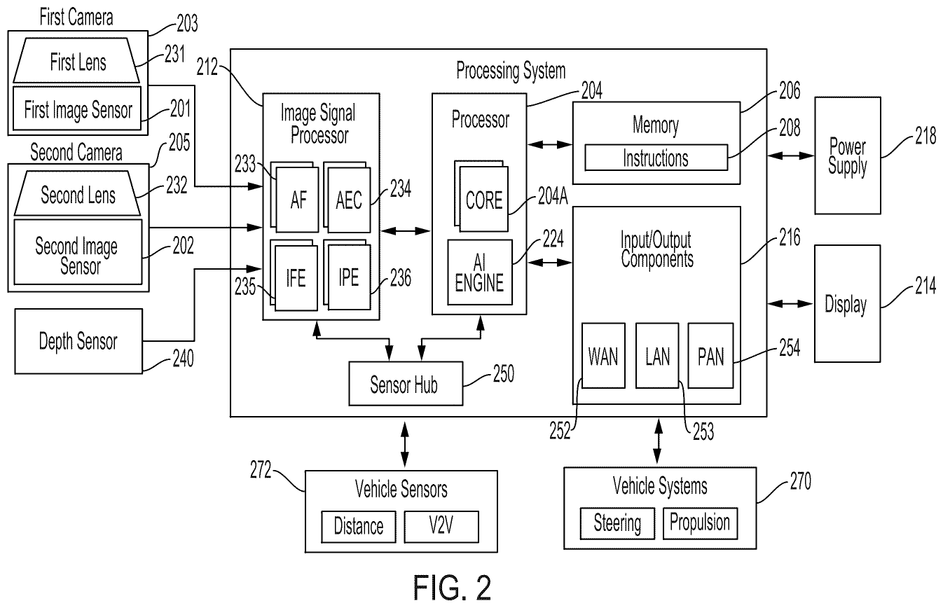

FIG. 2 shows a block diagram of an example image processing configuration for a vehicle according to one or more aspects of the disclosure. The vehicle 100 may include, or otherwise be coupled to, an image signal processor 212 for processing image frames from one or more image sensors, such as a first image sensor 201, a second image sensor 202, and a depth sensor 240. In some implementations, the vehicle 100 also includes or is coupled to a processor (e.g., CPU) 204 and a memory 206 storing instructions 208. The device 100 may also include or be coupled to a display 214 and input/output (I/O) components 216. I/O components 216 may be used for interacting with a user, such as a touch screen interface and/or physical buttons. I/O components 216 may also include network interfaces for communicating with other devices, such as other vehicles, an operator's mobile devices, and/or a remote monitoring system. The network interfaces may include one or more of a wide area network (WAN) adaptor 252, a local area network (LAN) adaptor 253, and/or a personal area network (PAN) adaptor 254. An example WAN adaptor 252 is a 4G LTE or a 5G NR wireless network adaptor. An example LAN adaptor 253 is an IEEE 802.11 WiFi wireless network adapter. An example PAN adaptor 254 is a Bluetooth wireless network adaptor. Each of the adaptors 252, 253, and/or 254 may be coupled to an antenna, including multiple antennas configured for primary and diversity reception and/or configured for receiving specific frequency bands. The vehicle 100 may further include or be coupled to a power supply 218, such as a battery or an alternator. The vehicle 100 may also include or be coupled to additional features or components that are not shown in FIG. 2. In one example, a wireless interface, which may include one or more transceivers and associated baseband processors, may be coupled to or included in WAN adaptor 252 for a wireless communication device. In a further example, an analog front end (AFE) to convert analog image frame data to digital image frame data may be coupled between the image sensors 201 and 202 and the image signal processor 212.

The vehicle 100 may include a sensor hub 250 for interfacing with sensors to receive data regarding movement of the vehicle 100, data regarding an environment around the vehicle 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub 250 may interface to a vehicle bus for sending configuration commands and/or receiving information from vehicle sensors 272, such as distance (e.g., ranging) sensors or vehicle-to-vehicle (V2V) sensors (e.g., sensors for receiving information from nearby vehicles).

The image signal processor (ISP) 212 may receive image data, such as used to form image frames. In one embodiment, a local bus connection couples the image signal processor 212 to image sensors 201 and 202 of a first camera 203, which may correspond to camera 112 of FIG. 1, and second camera 205, which may correspond to camera 114 of FIG. 1, respectively. In another embodiment, a wire interface may couple the image signal processor 212 to an external image sensor. In a further embodiment, a wireless interface may couple the image signal processor 212 to the image sensor 201, 202.

The first camera 203 may include the first image sensor 201 and a corresponding first lens 231. The second camera 205 may include the second image sensor 202 and a corresponding second lens 232. Each of the lenses 231 and 232 may be controlled by an associated autofocus (AF) algorithm 233 executing in the ISP 212, which adjust the lenses 231 and 232 to focus on a particular focal plane at a certain scene depth from the image sensors 201 and 202. The AF algorithm 233 may be assisted by depth sensor 240. In some embodiments, the lenses 231 and 232 may have a fixed focus.

The first image sensor 201 and the second image sensor 202 are configured to capture one or more image frames. Lenses 231 and 232 focus light at the image sensors 201 and 202, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging.

In some embodiments, the image signal processor 212 may execute instructions from a memory, such as instructions 208 from the memory 206, instructions stored in a separate memory coupled to or included in the image signal processor 212, or instructions provided by the processor 204. In addition, or in the alternative, the image signal processor 212 may include specific hardware (such as one or more integrated circuits (ICs)) configured to perform one or more operations described in the present disclosure. For example, the image signal processor 212 may include one or more image front ends (IFEs) 235, one or more image post-processing engines (IPEs) 236, and or one or more auto exposure compensation (AEC) 234 engines. The AF 233, AEC 234, IFE 235, IPE 236 may each include application-specific circuitry, be embodied as software code executed by the ISP 212, and/or a combination of hardware within and software code executing on the ISP 212.

In some implementations, the memory 206 may include a non-transient or non-transitory computer readable medium storing computer-executable instructions 208 to perform all or a portion of one or more operations described in this disclosure. In some implementations, the instructions 208 include a camera application (or other suitable application) to be executed during operation of the vehicle 100 for generating images or videos. The instructions 208 may also include other applications or programs executed for the vehicle 100, such as an operating system, mapping applications, or entertainment applications. Execution of the camera application, such as by the processor 204, may cause the vehicle 100 to generate images using the image sensors 201 and 202 and the image signal processor 212. The memory 206 may also be accessed by the image signal processor 212 to store processed frames or may be accessed by the processor 204 to obtain the processed frames. In some embodiments, the vehicle 100 includes a system on chip (SoC) that incorporates the image signal processor 212, the processor 204, the sensor hub 250, the memory 206, and input/output components 216 into a single package.

In some embodiments, at least one of the image signal processor 212 or the processor 204 executes instructions to perform various operations described herein, including object detection, risk map generation, driver monitoring, and driver alert operations. For example, execution of the instructions can instruct the image signal processor 212 to begin or end capturing an image frame or a sequence of image frames. In some embodiments, the processor 204 may include one or more general-purpose processor cores 204A capable of executing scripts or instructions of one or more software programs, such as instructions 208 stored within the memory 206. For example, the processor 204 may include one or more application processors configured to execute the camera application (or other suitable application for generating images or video) stored in the memory 206.

In executing the camera application, the processor 204 may be configured to instruct the image signal processor 212 to perform one or more operations with reference to the image sensors 201 or 202. For example, the camera application may receive a command to begin a video preview display upon which a video comprising a sequence of image frames is captured and processed from one or more image sensors 201 or 202 and displayed on an informational display on display 114 in the cabin of the vehicle 100.

In some embodiments, the processor 204 may include ICs or other hardware (e.g., an artificial intelligence (AI) engine 224) in addition to the ability to execute software to cause the vehicle 100 to perform a number of functions or operations, such as the operations described herein. In some other embodiments, the vehicle 100 does not include the processor 204, such as when all of the described functionality is configured in the image signal processor 212.

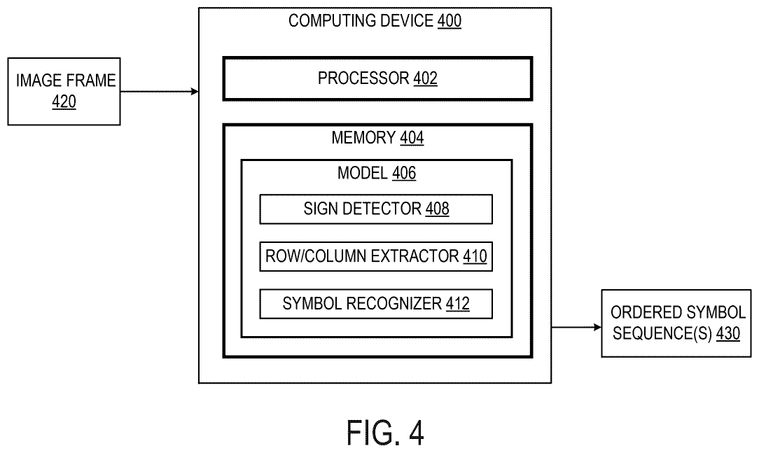

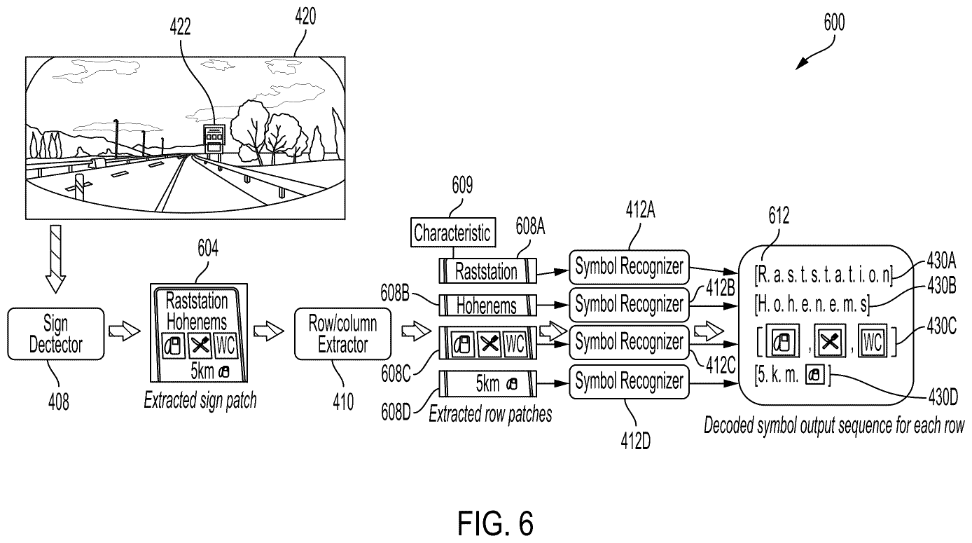

In some embodiments, the display 214 may include one or more suitable displays or screens allowing for user interaction and/or to present items to the user, such as a preview of the image frames being captured by the image sensors 201 and 202. In some embodiments, the display 214 is a touch-sensitive display. The I/O components 216 may be or include any suitable mechanism, interface, or device to receive input (such as commands) from the user and to provide output to the user through the display 214. For example, the I/O components 216 may include (but are not limited to) a graphical user interface (GUI), a keyboard, a mouse, a microphone, speakers, a squeezable bezel, one or more buttons (such as a power button), a slider, a switch, and so on. In some embodiments involving autonomous driving, the I/O components 216 may include an interface to a vehicle's bus for providing commands and information to and receiving information from vehicle systems 270 including propulsion (e.g., commands to increase or decrease speed or apply brakes) and steering systems (e.g., commands to turn wheels, change a route, or change a final destination). The accuracy of the output of commands to the vehicle systems 270 may be improved according to embodiments of this disclosure by using one or more machine learning models, such as that described in connection with FIGS. 4 and 6, to determine information conveyed by signboards (e.g., traffic signs) that can affect the commands sent to the vehicle systems 270.

While shown to be coupled to each other via the processor 204, components (such as the processor 204, the memory 206, the image signal processor 212, the display 214, and the I/O components 216) may be coupled to each another in other various arrangements, such as via one or more local buses, which are not shown for simplicity. While the image signal processor 212 is illustrated as separate from the processor 204, the image signal processor 212 may be a core of a processor 204 that is an application processor unit (APU), included in a system on chip (SoC), or otherwise included with the processor 204. While the vehicle 100 is referred to in the examples herein for including aspects of the present disclosure, some device components may not be shown in FIG. 2 to prevent obscuring aspects of the present disclosure. Additionally, other components, numbers of components, or combinations of components may be included in a suitable vehicle for performing aspects of the present disclosure. As such, the present disclosure is not limited to a specific device or configuration of components, including the vehicle 100.

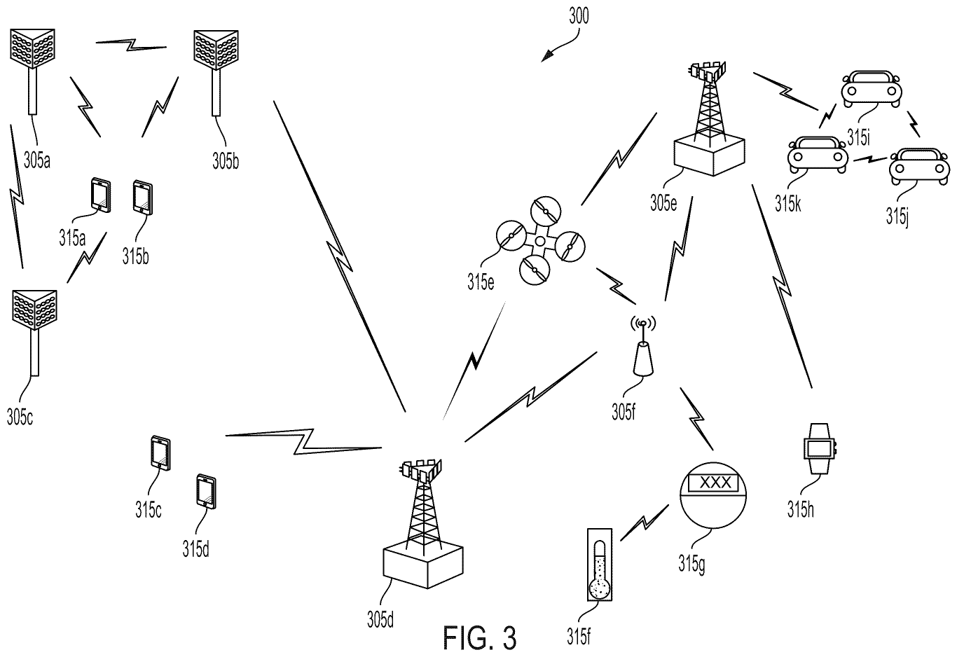

The vehicle 100 may communicate as a user equipment (UE) within a wireless network 300, such as through WAN adaptor 252, as shown in FIG. 3. FIG. 3 is a block diagram illustrating details of an example wireless communication system according to one or more aspects. Wireless network 300 may, for example, include a 5G wireless network. As appreciated by those skilled in the art, components appearing in FIG. 3 are likely to have related counterparts in other network arrangements including, for example, cellular-style network arrangements and non-cellular-style-network arrangements (e.g., device-to-device or peer-to-peer or ad-hoc network arrangements, etc.).

Wireless network 300 illustrated in FIG. 3 includes base stations 305 and other network entities. A base station may be a station that communicates with the UEs and may also be referred to as an evolved node B (eNB), a next generation eNB (gNB), an access point, and the like. Each base station 305 may provide communication coverage for a particular geographic area. In 3GPP, the term “cell” may refer to this particular geographic coverage area of a base station or a base station subsystem serving the coverage area, depending on the context in which the term is used. In implementations of wireless network 300 herein, base stations 305 may be associated with a same operator or different operators (e.g., wireless network 300 may include a plurality of operator wireless networks). Additionally, in implementations of wireless network 300 herein, base station 305 may provide wireless communications using one or more of the same frequencies (e.g., one or more frequency bands in licensed spectrum, unlicensed spectrum, or a combination thereof) as a neighboring cell. In some examples, an individual base station 305 or UE 315 may be operated by more than one network operating entity. In some other examples, each base station 305 and UE 315 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 3, base stations 305d and 305e are regular macro base stations, while base stations 305a-305c are macro base stations enabled with one of three-dimension (3D), full dimension (FD), or massive MIMO. Base stations 305a-305c take advantage of their higher dimension MIMO capabilities to exploit 3D beamforming in both elevation and azimuth beamforming to increase coverage and capacity. Base station 305f is a small cell base station which may be a home node or portable access point. A base station may support one or multiple (e.g., two, three, four, and the like) cells.

Wireless network 300 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 315 are dispersed throughout the wireless network 300, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology.

Some non-limiting examples of a mobile apparatus, such as may include implementations of one or more of UEs 315, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), and a vehicle. Although UEs 315a-j are specifically shown as vehicles, a vehicle may employ the communication configuration described with reference to any of the UEs 315a-315k.

In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 315a-315d of the implementation illustrated in FIG. 3 are examples of mobile smart phone-type devices accessing wireless network 300. A UE may also be a machine specifically configured for connected communication, including machine type communication (MTC), enhanced MTC (eMTC), narrowband IoT (NB-IoT) and the like. UEs 315e-315k illustrated in FIG. 3 are examples of various machines configured for communication that access wireless network 300.

A mobile apparatus, such as UEs 315, may be able to communicate with any type of the base stations, whether macro base stations, pico base stations, femto base stations, relays, and the like. In FIG. 3, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 300 may occur using wired or wireless communication links.

In operation at wireless network 300, base stations 305a-305c serve UEs 315a and 315b using 3D beamforming and coordinated spatial techniques, such as coordinated multipoint (CoMP) or multi-connectivity. Macro base station 305d performs backhaul communications with base stations 305a-305c, as well as small cell, base station 305f. Macro base station 305d also transmits multicast services which are subscribed to and received by UEs 315c and 315d. Such multicast services may include mobile television or stream video, or may include other services for providing community information, such as weather emergencies or alerts, such as Amber alerts or gray alerts.

Wireless network 300 of implementations supports communications with ultra-reliable and redundant links for certain devices. Redundant communication links with UE 315e include from macro base stations 305d and 305e, as well as small cell base station 305f. Other machine type devices, such as UE 315f (thermometer), UE 315g (smart meter), and UE 315h (wearable device) may communicate through wireless network 300 either directly with base stations, such as small cell base station 305f, and macro base station 305e, or in multi-hop configurations by communicating with another user device which relays its information to the network, such as UE 315f communicating temperature measurement information to the smart meter, UE 315g, which is then reported to the network through small cell base station 305f. Wireless network 300 may also provide additional network efficiency through dynamic, low-latency TDD communications or low-latency FDD communications, such as in a vehicle-to-vehicle (V2V) mesh network between UEs 315i-315k communicating with macro base station 305e.

Aspects of the vehicular systems described with reference to, and shown in, FIG. 1, FIG. 2, and FIG. 3 may include determining an ordered sequence of symbols on a signboard (e.g., a traffic sign) using image processing techniques. These techniques involve object detection to identify a signboard within an image frame. Once detected, a sign image patch representing the signboard is extracted from the frame. Further object detection is applied to the sign image patch to identify rows or columns of information displayed on the signboard. For instance, a signboard might show a rest stop in the first row, services available at the rest stop in the second row, and the distance to the rest stop in the third row.

For each row or column of information, the symbols conveying the information are extracted into an ordered sequence. Instead of using object detection to extract an image patch containing a symbol, the techniques utilize at least one machine learning model trained to read the information by extracting each symbol individually and determining their order. For example, if a signboard reads “Rest Stop”, each letter is extracted and ordered to form the words on the signboard. Similarly, if the signboard shows symbols for a gas station, dining, and a restaurant, each symbol is extracted and ordered. These ordered symbol sequences can then be used in downstream tasks, such as guiding an autonomous vehicle to the rest stop.

FIG. 4 is a block diagram illustrating an example computing device 400. Computing device 400 receives as input an image frame 420 and outputs at least one ordered symbol sequence 430. The image frame 420 represents an environment that includes a signboard. The at least one ordered symbol sequence 430 is indicative of information conveyed by the signboard. Computing device 400 may be implemented by the image processing configuration of FIG. 2 or by one or more of the components illustrated in FIG. 3.

Computing device 400 includes a processor 402 (e.g., processor 204) coupled to a memory 404 (e.g., memory 206). In various aspects, processor 402 may include more than one processor. For example, processor 402 may include a first processor 402A (not shown) and a second processor 402B (not shown) that are each coupled to the memory 404. The first processor 402A may be in communication with the second processor 402B. The first processor 402A and the second processor 402B may each perform all of the operations performed by processor 402, or alternatively, the first processor 402A may only perform a first portion of the operations and the second processor 402B may only perform a second portion of the operations.

In various aspects, memory 404 may include more than one memory. For example, memory 404 may include a first memory 404A (not shown) and a second memory 404B (not shown) that are each coupled to processor 402. The first memory 404A and the second memory 404B may each store all of the processor-executable code for all of the operations of processor 402, or alternatively, the first memory 404A may only store a first portion of the processor-executable code and the second memory 404B may only store a second portion of the processor-executable code. In another example, processor 402 may include the first processor 402A and the second processor 402B that are each coupled to a first memory 404A (not shown) and a second memory 404B (not shown) of memory 404. In another example, processor 402 may include the first processor 402A coupled to the first memory 404A of memory 404, but not to the second memory 404B of memory 404, and the second processor 402B coupled to the second memory 404B, but not to the first memory 404B.

In aspects in which processor 402 includes two or more processors, the two or more processors may be included with the same computing device 400, or may be suitably separated among two or more computing devices 400. In aspects in which memory 404 includes two or more memories, the two or more memories may be included with the same computing device 400, or may be suitably separated among two or more computing devices 400. The computing device(s) 400 with which the two or more memories of memory 404 are included may be the same computing device(s) 400 with which the at least one processor of processor 402 is included or may be different. For example, a processor 402 may be included with a first computing device 400A (not shown) and a memory 404 may be included with a second computing device 400B (not shown), e.g., a server, in communication with the first computing device 400A over a network.

The at least one memory 404 stores a model 406. Model 406 is trained to output the at least one ordered symbol sequence 430 based on the input image frame 420. In this way, model 406 predicts the information conveyed by a signboard. For example, model 406 may be implemented as one or more machine learning models, including supervised learning models, unsupervised learning models, other types of machine learning models, and/or other types of predictive models. For example, model 406 may be implemented as one or more of a neural network (e.g., a convolutional neural network), a transformer model, a decision tree model, a support vector machine, a Bayesian network, a classifier model, a regression model, and the like.

In various embodiments, model 406 includes a sign detector 408 that is trained to output bounding boxes of signboards based on an input image frame. For example, sign detector 408 may output a first image patch representing a signboard.

In various embodiments, model 406 includes a row/column extractor 410 that is trained to output a horizontal row or vertical column of information (e.g., symbols) based on an input image patch representing a signboard.

In various embodiments, model 406 includes at least one symbol recognizer 412 that is trained to output an ordered sequence of symbols based on an input image patch representing a horizontal row or vertical column of information. The at least one symbol recognizer 412 does not provide information regarding a position of a symbol in the input image patch nor in the image frame. A position of the symbol on a signboard is not needed in the present techniques to interpret the information conveyed by the symbol. Stated differently, the at least one symbol recognizer 412 does not extract an image patch including a symbol from the input image patch, but rather extracts a symbol from the input image patch.

In an example, each of sign detector 408, row extractor 410, and the at least one symbol recognizer 412 may be implemented as a separate layer of model 406. For example, each of sign detector 408, row extractor 410, the at least one symbol recognizer 412 may be implemented as one or more machine learning models, including supervised learning models, unsupervised learning models, other types of machine learning models, and/or other types of predictive models. For example, each of sign detector 408, row extractor 410, and the at least one symbol recognizer 412 may be implemented as one or more of a neural network (e.g., a convolutional neural network), a transformer model, a decision tree model, a support vector machine, a Bayesian network, a classifier model, a regression model, and the like.

In some embodiments, row/column extractor 410 may include a machine learning model trained to detect both rows and columns of information. In other embodiments, row/column extractor 410 may include a first machine learning model trained to detect rows of information and a second machine learning model trained to detect columns of information.

Model 406, including sign detector 408, row extractor 410, and symbol recognizer 412, may be trained based on training data to receive an image frame and output at least one ordered sequence of symbols that are displayed on a signboard represented in the image frame. For example, one or more training datasets may be used that contain image frames representing an environment that includes at least one signboard. The training data sets may specify one or more expected outputs. For example, an ordered sequence of symbols (e.g., a word) that a signboard displays. Parameters of model 406 may be updated based on whether model 406 generates correct outputs when compared to the expected outputs. In particular, model 406 may receive one or more pieces of input data from the training data sets that are associated with a plurality of expected outputs. Model 406 may generate predicted outputs based on a current configuration of model 406. The predicted outputs may be compared to the expected outputs and one or more parameter updates may be computed based on differences between the predicted outputs and the expected outputs. In particular, the parameters may include weights (e.g., priorities) for different features and combinations of features (e.g., shape of letters, space separating two different symbols, etc.). The parameter updates to model 406 may include updating one or more of the features analyzed and/or the weights assigned to different features or combinations of features (e.g., relative to the current configuration of model 406).

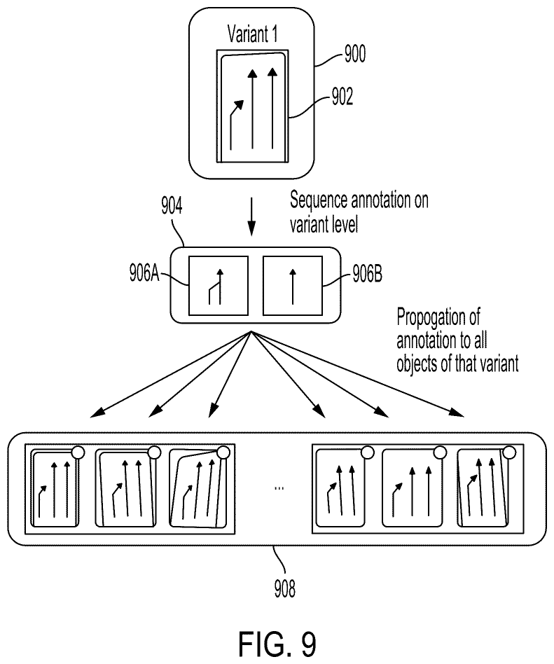

The present techniques may provide the benefit of streamlined annotations for training data by grouping signboards into variants and annotating only once per variant. For instance, FIG. 9 shows a variant 900 that is represented by a signboard 902 including a left merge arrow and two straight arrows. Prior to the annotation stage, a plurality of signboards 908 in the training data that look substantially similar (e.g., conveying the same information, exactly the same except for minor differences, etc.) to signboard 902 are mapped to variant 900.

An annotation 904 can be attributed to variant 900 that includes a left-lane-merge symbol 906A indicative of the information conveying the left lane is merging into the center lane, and a straight-arrow symbol 906B indicative of the information conveying the right lane is proceeding straight. The one annotation 904 can then be propagated to every signboard of the plurality of signboards 908 mapped to variant 900. Additionally, as new training data is received, each new signboard that looks substantially similar to (e.g., has the same symbols as) signboard 902 can be mapped to variant 900 and automatically inherit annotation 904. Annotating in this way is enabled, in part, by the present techniques eliminating the need for a detailed bounding box for each symbol.

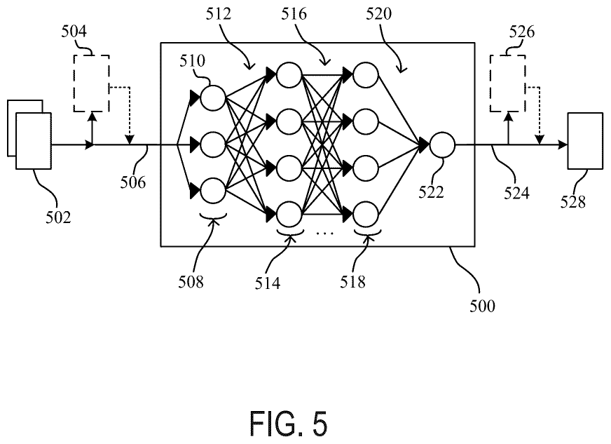

FIG. 5 is an illustrative block diagram of an example machine learning (ML) model, that may be implemented as model 406, represented by an artificial neural network (ANN) 500 (e.g., a convolutional neural network). ANN 500 may receive input data 506 which may include one or more bits of data 502, pre-processed data output from pre-processor 504 (optional), or some combination thereof. Here, data 502 may include training data, verification data, application-related data, or the like, e.g., depending on the stage of deployment of ANN 500. Pre-processor 504 may be included within ANN 500 in some other implementations. Pre-processor 504 may, for example, process all or a portion of data 502 which may result in some of data 502 being changed, replaced, deleted, etc. In some implementations, pre-processor 504 may add additional data to data 502. In some implementations, the pre-processor 504 may be a ML model, such as an ANN.

ANN 500 includes at least one first layer 508 of artificial neurons 510 to process input data 506 and provide resulting first layer data via edges 512 to at least a portion of at least one second layer 514. Second layer 514 processes data received via edges 512 and provides second layer output data via edges 516 to at least a portion of at least one third layer 518. Third layer 518 processes data received via edges 516 and provides third layer output data via edges 520 to at least a portion of a final layer 522 including one or more neurons to provide output data 524. All or part of output data 524 may be further processed in some manner by (optional) post-processor 526. Thus, in certain examples, ANN 500 may provide output data 528 that is based on output data 524, post-processed data output from post-processor 526, or some combination thereof. Post-processor 526 may be included within ANN 500 in some other implementations. Post-processor 526 may, for example, process all or a portion of output data 524 which may result in output data 528 being different, at least in part, to output data 524, e.g., as result of data being changed, replaced, deleted, etc. In some implementations, post-processor 526 may be configured to add additional data to output data 524. In this example, second layer 514 and third layer 518 represent intermediate or hidden layers that may be arranged in a hierarchical or other like structure. Although not explicitly shown, there may be one or more further intermediate layers between the second layer 514 and the third layer 518. In some implementations, the post-processor 526 may be a ML model, such as an ANN.

The structure and training of artificial neurons 510 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process or during operation of the ML model. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the configuration for the ML model to change in response to identifying complex patterns and relationships in the input data 506 and determinations that should be made when those complex patterns and relationships are identified in the input data. Some non-exhaustive example activation functions include a sigmoid based activation function, a hyperbolic tangent (tanh) based activation function, a convolutional activation function, up-sampling, pooling, and a rectified linear unit (ReLU) based activation function.

FIG. 6 is a flow diagram of an example pipeline 600 for determining, using image processing techniques, an ordered sequence of symbols included on a signboard. Pipeline 600 includes sign detector 408 receiving image frame 420 that includes a signboard 422. Sign detector 408 extracts a first image patch 604 from image frame 420. First image patch 604 includes a plurality of pixels representing signboard 422. For example, a bounding box detecting signboard 422 may define first image patch 604.

First image patch 604 is input to row/column extractor 410 which outputs a plurality of second image patches 608A-608D from first image patch 604. In this example, signboard 422 includes information arranged in rows. Specifically, signboard 422 includes a first row that conveys “Raststation”, a second row that conveys “Hohenems”, a third row that conveys a gas symbol, a food symbol, and a restroom symbol, and a fourth row that conveys a distance of “5 km” and an arrow symbol. As such, second image patch 608A includes a plurality of pixels representing the first row of information conveying “Raststation”. Second image patch 608B includes a plurality of pixels representing the second row of information conveying “Hohenems”. Second image patch 608C includes a plurality of pixels representing the third row of information conveying the gas symbol, the food symbol, and the restroom symbol. And second image patch 608D includes a plurality of pixels representing the fourth row of information conveying the distance of “5 km” and the arrow symbol.

In the illustrated example, the at least one symbol recognizer 412 includes a dedicated symbol recognizer for each of second image patches 608A-608D. Second image patch 608A is input to symbol recognizer 412A which outputs an ordered symbol sequence 430A. Ordered symbol sequence 430A includes a plurality of symbols 612. For instance, each individual letter of the word “Raststation” conveyed by second image patch 608A is extracted by symbol recognizer 412A as a symbol 612. In FIG. 6, each symbol 612 is separated by a comma.

Second image patch 608B is input to symbol recognizer 412B which outputs an ordered symbol sequence 430B. Ordered symbol sequence 430B includes a plurality of symbols 612. For instance, each individual letter of the word “Hohenems” conveyed by second image patch 608B is extracted by symbol recognizer 412B as a symbol 612. In FIG. 6, each symbol 612 is separated by a comma.

Second image patch 608C is input to symbol recognizer 412C which outputs an ordered symbol sequence 430C. Ordered symbol sequence 430C includes a plurality of symbols 612. For instance, each of the three symbols conveyed by second image patch 608C is extracted by symbol recognizer 412C as a symbol 612. In FIG. 6, each symbol 612 is separated by a comma.

Second image patch 608D is input to symbol recognizer 412D which outputs an ordered symbol sequence 430D. Ordered symbol sequence 430D includes a plurality of symbols 612. For instance, each individual number and letter of “5 km” and the arrow symbol conveyed by second image patch 608D is extracted by symbol recognizer 412D as a symbol 612. In FIG. 6, each symbol 612 is separated by a comma.

Each of the ordered symbol sequences 430A-430D may thereafter be provided to a downstream task. For example, a driving assistance system that controls operations of vehicle 100 based on the interpreted information from signboard 422.

In some embodiments, one or more of symbol recognizers 412A-412D may output respective symbol indexes (e.g., an integer value) that are used in conjunction with a data table stored in at least one memory 404 to determine a respective symbol corresponding to the symbol index.

In some embodiments, one or more machine learning models implementing row/column extractor 410 may be trained to provide a characteristic of at least one of the second image patches 608A-608D. For example, second image patch 608A is shown to be associated with a characteristic 609. For example, the row/column extractor 412 could be trained to provide a language of the signboard lettering included in the second image patch 608A, such as English, German, or Japanese. In another example, the row/column extractor 412 could be trained to provide a type of script of the signboard lettering included in the second image patch 608A, such as Latin script or Chinese script or symbols. In another example, row/column extractor 412 could be trained to provide an indication of whether the second image patch 608A is a row of information or a column of information.

The characteristic may indicate which particular symbol recognizer (e.g., symbol recognizer 412A) of symbol recognizers 412A-412D should be used to determine the plurality of symbols 612 in the second image patch 608A. For example, each respective symbol recognizer 412A-412D could be trained to detect symbols having one or more respective characteristics (e.g., language type, script type, etc.). Stated differently, symbol recognizer 412A could be trained to detect information in English and symbol recognizer 412B may be trained to detect information in Japanese. In another example, the indication may indicate that the second image patch 608A should be input to symbol recognizer 412A that is trained to recognize symbols in rows rather than symbol recognizer 412B that is trained to recognize symbols in columns.

A symbol recognizer 412 may be trained to recognize symbols for a group of characteristics in other aspects. For example, symbol recognizer 412A may be trained to recognize symbols in all languages or in a subset of languages. In another example, symbol recognizer 412A may be trained to recognize symbols in both rows and columns.

In some embodiments, row/column extractor 410 may be omitted. For example, the at least one symbol recognizer 412 may be trained to extract symbols directly from first image patch 604. In these embodiments, the one or more ML models implementing the at least one symbol recognizer 412 are trained to predict a new row/column token to separate the different rows or columns of information represented in first image patch 604. One or more ML models with an attention mechanism, such as a transformer ML model, may be used to account for the lack of spatial alignment between first image patch 604 and ordered symbol sequence 430.

When row/column extractor 410 is omitted, the first image patch 604 may be used to determine a characteristic of at least a portion of the information included on the signboard 422. Each symbol 612 included in the at least a portion of the information is then determined based on the characteristic.

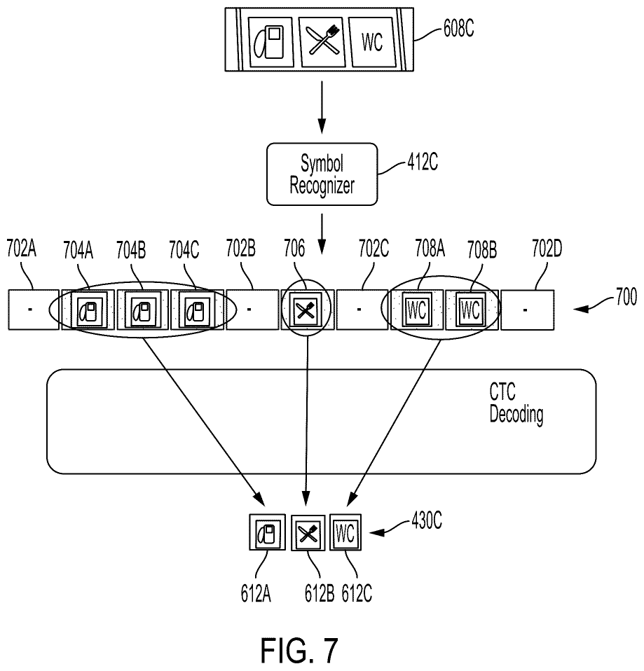

FIG. 7 shows an example embodiment in which a symbol recognizer (e.g., symbol recognizer 412C) is trained using CTC loss to determine ordered symbol sequence 430. In this example, an output tensor 700 (e.g., a CTC output) of symbol recognizer 412C can be decoded using a separate CTC decoding step of model 406 at the inference stage. In another example, the symbol recognizer 412C may include the CTC decoding process such that an output of the symbol recognizer 412C is the decoded output tensor 700. The use of a CTC algorithm in this way eliminates the need to annotate detailed bounding boxes of all the symbols in image patch 608C, which would be computationally expensive to process. For instance, while the alignment between the output positions of ordered symbol sequence 430 and the symbols in the input image patch 608C is unknown without the detailed bounding boxes, the CTC algorithm allows model 406 (e.g., symbol recognizer 412C) to predict a token at each position in the output and repeat that token as long as model 406 succeeds in predicting a blank token.

For example, output tensor 700 includes repeated predictions 704A-704C for the first, left-most symbol in image patch 608C and repeated predictions 708A, 708B for the last, right-most symbol in image patch 608C. Output tensor 700 also includes predictions 702A-702D that are each a blank token to separate the three symbols in image patch 608C. In this way, when the CTC decoding is applied to output tensor 700, the ordered symbol sequence 430C will include a single symbol 612A for the first, left-most symbol in image patch 608C, a single symbol 612B for the second, middle symbol in image patch 608C, and a single symbol 612C for the last, right-most symbol in image patch 608C, which matches image patch 608C.

In other embodiments, symbol recognizer 412C may be trained to output ordered symbol sequence 430 based on input image patch 608C using any other suitable technique other than CTC loss. For example, a suitable technique may be a transformer ML model or a recurrent neural network (RNN), such as a long short-term memory neural network. To handle predictions of varying sequence length, an end of sequence (EOS) symbol or the like may be appended to the ground truth sequence when training these ML models. In this way, only symbols before the EOS symbol are output from the trained ML models. In some aspects of these embodiments, a categorical cross entropy loss can be used on each symbol in the predicted ordered symbol sequence 430, where a predicted symbol is compared with the ground truth symbol, while ignoring symbols after the EOS symbol is found in the ground truth sequence.

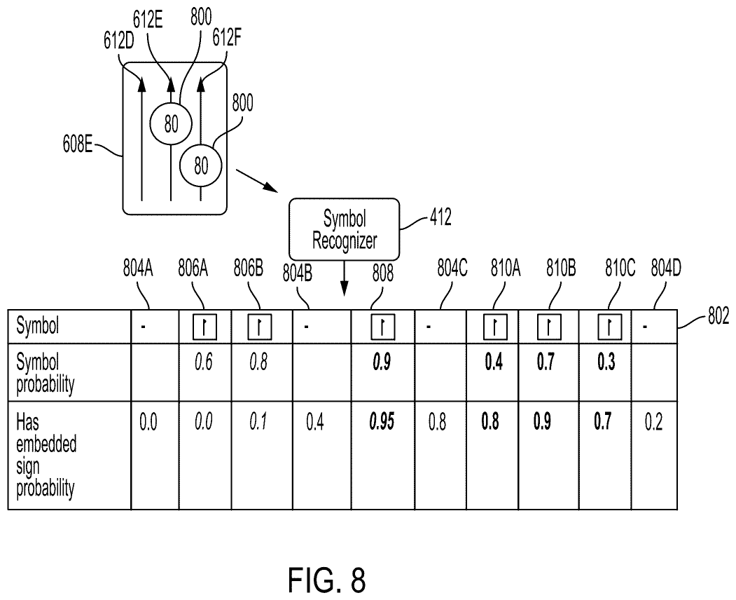

Signboards may sometimes include different variations of similar symbols. For example, FIG. 8 shows an information image patch 608E of a signboard including three arrow symbols 612D, 612E, and 612F indicative of three lanes on a road. Arrow symbols 612E and 612F are each additionally associated with an additional symbol overlaid on top of the arrow symbol, whereas arrow symbol 612D is not. Specifically, arrow symbol 612E is associated with a symbol 800 indicative of a speed limit for the respective lane overlaid on the arrow. Arrow symbol 612F is similarly associated with the symbol 800. Embodiments of the provided techniques (e.g., of symbol recognizer 412) are able to jointly estimate symbol-level attributes.

For example, when symbol recognizer 412 is trained using CTC loss, inputting information image patch 608E to symbol recognizer 412 results in an output tensor 802. Output tensor 802 includes repeated predictions 806A, 806B for the symbol 612D, a prediction 808 for the symbol 612E, and repeated predictions 810A, 810B, and 810C for the symbol 612F. Output tensor 802 also includes predictions 804A-804D that are each a blank token to separate the three symbols 612D, 612E, 612F in image patch 608E.

Output tensor 802 (e.g., a CTC output) can be decoded using a separate CTC decoding step of model 406 at the inference stage, or symbol recognizer 412C may include the CTC decoding process such that an output of the symbol recognizer 412C is the decoded output tensor 802. In either case, the CTC output provides a symbol probability at each position in output tensor 802, indicating the probability that the predicted symbol is correct. Specifically, as shown in the table of FIG. 8, predictions 806A and 806B have respective probabilities of 0.6 and 0.8, prediction 808 has a probability of 0.9, and predictions 810A, 810B, and 810C have respective probabilities of 0.4, 0.7, and 0.3.

An attribute decoding algorithm serves as an extension to the CTC decoding algorithm and assigns an attribute value to each symbol prediction. For example, an attribute value may be a probability that a symbol prediction is a particular variation of the symbol. In the present example, the attribute value is a probability that a symbol prediction includes (e.g., is overlaid with) symbol 800. Specifically, as shown in the table, prediction 804A has an attribute value of 0.0 of being associated with the symbol 800, prediction 806A has an attribute value of 0.0, prediction 806B has an attribute value of 0.1, prediction 804B has an attribute value of 0.4, prediction 808 as an attribute value of 0.95, prediction 804C has an attribute value of 0.8, prediction 810A has an attribute value of 0.8, prediction 810B has an attribute value of 0.9, prediction 810C has an attribute value of 0.7, and prediction 804D as an attribute value of 0.2.

Determining a final ordered symbol sequence 430 with the CTC algorithm and the attribute decoding algorithm includes collapsing repeated symbol predictions into a single symbol. For example, prediction 806A and 806B are collapsed into one symbol, prediction 810A, 810B and 810C are collapsed into one symbol. Determining the final ordered symbol sequence 430 with corresponding attribute values further includes taking weighted averages of the attribute predictions corresponding to the repeated predicted symbols that were collapsed, with the most weight being placed on an attribute prediction associated with a predicted symbol with the highest probability.. For example, among the attribute predictions of 0.8, 0.9, and 0.7 respectively associated with symbol predictions 810A, 810B, and 810C, the most weight is placed on attribute prediction 0.9 given that the prediction 810B has the highest probability of 0.7.

In the present example, whether a symbol does or does not have the symbol 800 overlaid on the arrow is a binary decision. In such an example, if the weighted average of attribute predictions for a symbol meets a predetermined threshold, then the symbol is predicted to have the symbol 800. If the weighted average of attribute predictions does not meet the predetermined threshold, then the symbol is predicted to not have the symbol 800. The present techniques, however, are not limited to binary decisions for symbol variations. For example, the present techniques may be used with categorical variations that include multiple states or with variations determined by regression outputs. For example, the attribute could be the length of the arrow, a color intensity of a symbol, and the like. In these non-binary decision examples, an attribute value indicates a probability that a symbol prediction is a particular variation of a plurality of variations.

In various embodiments, the one or more ML models implementing symbol recognizer 412 may include a plurality of ML models that are each trained to determine attribute values for a particular set of variations of a symbol. In other embodiments, the one or more ML models implementing symbol recognizer 412 may include a ML model that is trained to determine attribute values for more than one set of variations of one or more symbols.

The attribute decoding algorithm may be, for example, a transformer ML model or a recurrent neural network (RNN), such as a long short-term memory neural network. To handle predictions of varying sequence length, an end of sequence (EOS) symbol or the like may be appended to the ground truth sequence when training these ML models. In this way, only symbols before the EOS symbol are output from the trained ML models. In some aspects of these embodiments, a categorical cross entropy loss can be used on each symbol in the predicted ordered symbol sequence 430, where a predicted symbol is compared with the ground truth symbol, while ignoring symbols after the EOS symbol is found in the ground truth sequence.

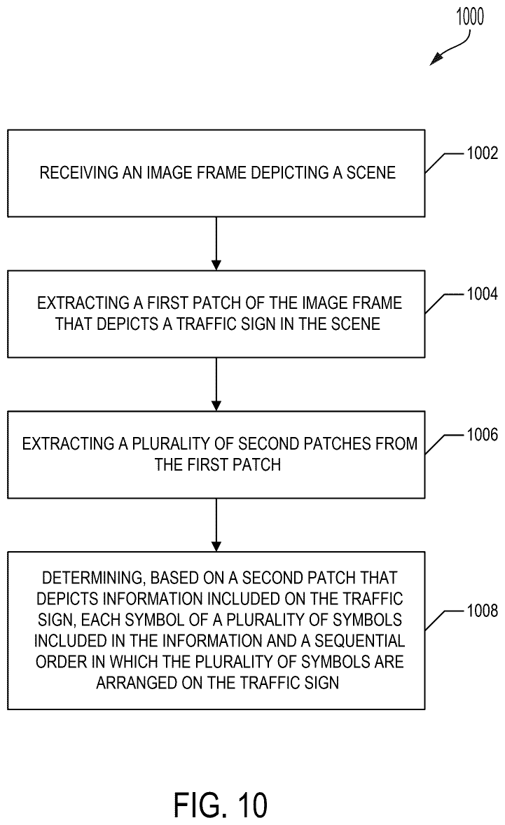

One method of performing image processing according to embodiments described above is shown in FIG. 10. FIG. 10 is a flow chart illustrating an example method 1000 for determining, using image processing techniques, an ordered sequence of symbols included on a signboard. Method 1000 includes, at block 1002, receiving an image frame (e.g., image frame 420) representing a scene. For example, image frame 420 may be received from image sensor 201 or image sensor 202.

At block 1004, a first image patch (e.g., image patch 604) of image frame 420 is extracted (e.g., by sign detector 408). The first image patch 604 includes a first plurality of pixels representing a signboard (e.g., signboard 422) in the scene. The signboard 422 includes information. In at least some aspects, the information included on the signboard 422 is arranged on the signboard 422 in a horizontal row or a vertical column.

At block 1006, method 1000 includes determining (e.g., by symbol recognizer 412A), based on the first image patch 608A, each symbol (e.g., symbol 612) of a plurality of symbols included in the information and an order in which the plurality of symbols are arranged on the signboard 422 (e.g., together are ordered symbol sequence 430A). In some aspects, each symbol 612 of the plurality of symbols and the sequential order in which the plurality of symbols are arranged are each determined based on a CTC algorithm.

In some embodiments, method 1000 further includes extracting (e.g., by row/column extractor 410) a plurality of second image patches (e.g., image patches 608A-608D) from first image patch 604. A second image patch (e.g., image patch 608A) of the plurality of second image patches 608A-608D includes a second plurality of pixels representing a portion of the information included on the signboard 422. For example, image patch 608A may represent a single row or single column of the information on the signboard 422. In these embodiments, determining each symbol 612 of the plurality of symbols included in the information and an order in which the plurality of symbols are arranged on the signboard 422 is based on the plurality of second image patches 608A-608D.

In some embodiments, method 1000 further includes determining a characteristic of at least a portion of the information included on the signboard 422 based on the first image patch 604. In such aspects, each symbol 612 included in the at least a portion of the information is determined based on the characteristic. In other embodiments, method 1000 further includes determining a characteristic of the information included on the signboard 422 based on the second image patch 608A. In such aspects, each symbol 612 of the plurality of symbols is determined based on the determined characteristic.

The plurality of second image patches 608A-608D may be extracted from the first image patch 604 using a first ML model (e.g., ML model implementing row/column extractor 410). In some embodiments, method 1000 then further includes selecting a second ML model (e.g., ML model implementing symbol recognizer 412A) from a plurality of ML models (e.g., all of the ML models implementing symbol recognizers 412A-412D) based on an output (e.g., a characteristic) of the first ML model, the output associated with a respective second image patch (e.g., image patch 608A) of the plurality of second image patches (e.g., image patches 608A-608D). The second machine learning model is used to determine each symbol 612 in the respective second image patch 608A and the order in which each symbol is arranged.

In some embodiments, a symbol 612 of the plurality of symbols may be associated with a plurality of variations of the symbol 612, and method 1000 further includes determining an attribute value for each symbol 612 of the plurality of symbols. The attribute value is indicative of a probability that the symbol is associated with a first variation of the plurality of variations.

In some embodiments, each symbol 612 of the plurality of symbols included in the information and the sequential order in which the plurality of symbols are arranged is determined based on a first ML model (e.g., the one or more ML models implementing symbol recognizer 412A), and another second image patch (e.g., image patch 608B) of the plurality of second image patches includes a third plurality of pixels representing second information included on the signboard 422. In such embodiments, the method further includes determining, based on image patch 608B and a second ML model (e.g., the one or more ML models implementing symbol recognizer 412B), each symbol 612 of a second plurality of symbols included in the second information and an order in which the second plurality of symbols are arranged (e.g., together are ordered symbol sequence 430B). The first ML model is trained differently than the second ML model in these embodiments.

In some embodiments, method 1000 may further include controlling a function of the vehicle 100 based on ordered symbol sequence 430A. For example, the ordered symbol sequence 430A may be input to a driving assistance system that processes the ordered symbol sequence 430 to control functions of the vehicle 100.

It is noted that one or more blocks (or operations) described with reference to FIGS. 4 and 5 may be combined with one or more blocks (or operations) described with reference to another of the figures. For example, one or more blocks (or operations) of FIG. 4 or 5 may be combined with one or more blocks (or operations) of FIGS. 1-3. As another example, one or more blocks (or operations) of FIG. 4 or 5 may be combined with one or more blocks (or operations) of FIGS. 6-9. As another example, one or more blocks associated with FIG. 5 may be combined with one or more blocks associated with FIG. 4.

In one or more aspects, techniques for supporting vehicular operations may include additional aspects, such as any single aspect or any combination of aspects described below or in connection with one or more other processes or devices described elsewhere herein. In a first aspect, an apparatus is configured to perform operations including receiving an image frame representing a scene and extracting a first image patch of the image frame. The first image patch includes a first plurality of pixels representing a signboard including information in the scene. The operations further include determining, based on the first image patch, each symbol of a plurality of symbols included in the information and an order in which the plurality of symbols are arranged on the signboard.

In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the information included on the signboard is arranged on the signboard in at least one horizontal row or at least one vertical column.

In a third aspect, in combination with one or more of the first aspect or the second aspect, each symbol of the plurality of symbols and the sequential order in which the plurality of symbols are arranged are each determined based on a connectionist temporal classification algorithm.

In a fourth aspect, in combination with one or more of the first aspect through the third aspect, the operations further include extracting a plurality of second image patches from the first image patch. In the fourth aspect, each second image patch of the plurality of second image patches includes a second plurality of pixels representing a portion of the information included on the signboard, and determining each symbol of the plurality of symbols and the order in which the plurality of symbols are arranged is based on the plurality of second image patches.

In a fifth aspect, in combination with the fourth aspect, the plurality of second image patches are extracted from the first image patch using a first machine learning model. The method further includes selecting a second machine learning model from a plurality of machine learning models based on an output of the first machine learning model, the output associated with a respective second image patch of the plurality of second image patches. The second machine learning model is used to determine each symbol in the respective second image patch and the order in which each symbol is arranged in the fifth aspect.

In a sixth aspect, in combination with one or more of the first aspect through the fifth aspect, the operations further include determining a characteristic of at least a portion of the information included on the signboard based on the first image patch. In the sixth aspect, each symbol included in the at least a portion of the information is determined based on the characteristic.

In a seventh aspect, in combination with one or more of the first aspect through the sixth aspect, a symbol of the plurality of symbols is associated with a plurality of variations of the symbol, the operations further include determining an attribute value for the symbol, and the attribute value is indicative of a probability that the symbol is a first variation of the plurality of variations.

In an eighth aspect, in combination with one or more of the first aspect through the seventh aspect, each symbol of the plurality of symbols included in the information and the sequential order in which the plurality of symbols are arranged is determined based on a first machine learning (ML) model, and another second image patch of the plurality of second image patches includes a third plurality of pixels representing second information included on the signboard. In the eighth aspect, the operations further include determining, based on the another second image patch and a second ML model, each symbol of a second plurality of symbols included in the second information and an order in which the second plurality of symbols are arranged. The first ML model is trained differently than the second ML model in the eighth aspect.

In a ninth aspect, in combination with one or more of the first aspect through the sixth aspect, the operations further include controlling a vehicle based on the sequential order of the plurality of symbols that is determined.

Components, the functional blocks, and the modules described herein with respect to FIGS. 1-8 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for image processing, comprising:
receiving an image frame representing a scene;
extracting a first image patch of the image frame, wherein the first image patch includes a first plurality of pixels representing a signboard in the scene, and wherein the signboard includes information; and
determining, based on the first image patch, each symbol of a plurality of symbols included in the information and an order in which the plurality of symbols are arranged on the signboard.

2. The method of claim 1, wherein the information included on the signboard is arranged on the signboard in at least one horizontal row or at least one vertical column.

3. The method of claim 1, wherein each symbol of the plurality of symbols and the sequential order in which the plurality of symbols are arranged are each determined based on a connectionist temporal classification algorithm.

4. The method of claim 1, further comprising extracting a plurality of second image patches from the first image patch, wherein:
each second image patch of the plurality of second image patches includes a second plurality of pixels representing a portion of the information included on the signboard, and
determining each symbol of the plurality of symbols and the order in which the plurality of symbols are arranged is based on the plurality of second image patches.

5. The method of claim 4, wherein the plurality of second image patches are extracted from the first image patch using a first machine learning model, the method further comprising:
selecting a second machine learning model from a plurality of machine learning models based on an output of the first machine learning model, the output associated with a respective second image patch of the plurality of second image patches,
wherein the second machine learning model is used to determine each symbol in the respective second image patch and the order in which each symbol is arranged.

6. The method of claim 1, further comprising determining a characteristic of at least a portion of the information included on the signboard based on the first image patch, wherein each symbol included in the at least a portion of the information is determined based on the characteristic.

7. The method of claim 1, wherein a symbol of the plurality of symbols is associated with a plurality of variations of the symbol, the method further comprising determining an attribute value for the symbol, and wherein the attribute value is indicative of a probability that the symbol is a first variation of the plurality of variations.

8. An apparatus, comprising:
a memory storing processor-readable code; and
at least one processor coupled to the memory, the at least one processor configured to execute the processor-readable code to cause the at least one processor to perform operations comprising:
receiving an image frame representing a scene;
extracting a first image patch of the image frame, wherein the first image patch includes a first plurality of pixels representing a signboard in the scene, and wherein the signboard includes information; and
determining, based on the first image patch, each symbol of a plurality of symbols included in the information and an order in which the plurality of symbols are arranged on the signboard.

9. The apparatus of claim 8, wherein the information included on the signboard is arranged on the signboard in at least one horizontal row or at least one vertical column.

10. The apparatus of claim 8, wherein each symbol of the plurality of symbols and the sequential order in which the plurality of symbols are arranged are each determined based on a connectionist temporal classification algorithm.

11. The apparatus of claim 8, wherein the operations further include extracting a plurality of second image patches from the first image patch, wherein:
each second image patch of the plurality of second image patches includes a second plurality of pixels representing a portion of the information included on the signboard, and
determining each symbol of the plurality of symbols and the order in which the plurality of symbols are arranged is based on the plurality of second image patches.

12. The apparatus of claim 8, wherein the operations further comprise determining a characteristic of at least a portion of the information included on the signboard based on the first image patch, wherein each symbol included in the at least a portion of the information is determined based on the characteristic.

13. The apparatus of claim 12, wherein the plurality of second image patches are extracted from the first image patch using a first machine learning model, and the operations further comprise:
selecting a second machine learning model from a plurality of machine learning models based on an output of the first machine learning model, the output associated with a respective second image patch of the plurality of second image patches,
wherein the second machine learning model is used to determine each symbol in the respective second image patch and the order in which each symbol is arranged.

14. The apparatus of claim 8, wherein a symbol of the plurality of symbols is associated with a plurality of variations of the symbol, the operations further comprising determining an attribute value for the symbol, and wherein the attribute value is indicative of a probability that the symbol is a first variation of the plurality of variations.

15. A non-transitory computer-readable medium storing instructions that, when executed by a processor, cause the processor to perform operations comprising:
receiving an image frame representing a scene;
extracting a first image patch of the image frame, wherein the first image patch includes a first plurality of pixels representing a signboard in the scene, and wherein the signboard includes information; and
determining, based on the first image patch, each symbol of a plurality of symbols included in the information and an order in which the plurality of symbols are arranged on the signboard.

16. The non-transitory computer-readable medium of claim 15, wherein the information included on the signboard is arranged on the signboard in at least one horizontal row or at least one vertical column.

17. The non-transitory computer-readable medium of claim 15, wherein the operations further include extracting a plurality of second image patches from the first image patch, wherein:
each second image patch of the plurality of second image patches includes a second plurality of pixels representing a portion of the information included on the signboard, and
determining each symbol of the plurality of symbols and the order in which the plurality of symbols are arranged is based on the plurality of second image patches.

18. The non-transitory computer-readable medium of claim 17, wherein the plurality of second image patches are extracted from the first image patch using a first machine learning model, and the operations further comprise:
selecting a second machine learning model from a plurality of machine learning models based on an output of the first machine learning model, the output associated with a respective second image patch of the plurality of second image patches,
wherein the second machine learning model is used to determine each symbol in the respective second image patch and the order in which each symbol is arranged.

19. The non-transitory computer-readable medium of claim 15, wherein each symbol of the plurality of symbols and the order in which the plurality of symbols are arranged are each determined based on a connectionist temporal classification algorithm.

20. The non-transitory computer-readable medium of claim 15, wherein a symbol of the plurality of symbols is associated with a plurality of variations of the symbol, the operations further comprising determining an attribute value for the symbol, and wherein the attribute value is indicative of a probability that the symbol is a first variation of the plurality of variations.
